(19) United States
(12) Patent Application Publication
(10) Pub. No.: US 2012/0264513 A1
(43) Pub. Date: Oct. 18, 2012

(54) GAME APPARATUS AND GAME PROVIDING METHOD

(75) Inventors: Sadaaki KANEYOSHI, Tokyo (JP); Shohei TADA, Tokyo (JP)

(73) Assignee: KONAMI DIGITAL ENTERTAINMENT CO., LTD., Tokyo (JP)

(21) Appl. No.: 13/448,949

(22) Filed: Apr. 17, 2012

(30) Foreign Application Priority Data
Apr. 18, 2011 (JP) 2011-091894

(51) Int. Cl. A63F 13/00

(52) U.S. Cl. 463/31

(57) ABSTRACT

A game apparatus allows a player to play a game using a character. A character assignment unit assigns the character to the player. An information storage unit stores parameters for the game and state information indicating a first state in which the parameters are maintained at an initial value or a second state in which the parameter is changeable for the character assigned to the player by the character assignment unit. An information management unit changes the state indicated by the state information from the first state to the second state. A display control unit causes a display device to display a first character image indicating the character if the state information of the character indicates the second state and causes the display device to display a second character image indicating the character in a mode different from the first character image if the state information of the character indicates the first state.

### BACKGROUND OF THE INVENTION

1. Field of the Invention

The present invention relates to a technology for allowing a user to play a game using a character.

2. Related Art

Conventionally, there have been proposed games in which an event such as a battle with an enemy character is executed while a character given to a player is made to grow. For example, Non-patent Document 1 (“Social Game Application Magazine “Appli-Style Vol. 2” by Eastpress, Apr. 1, 2011, pp. 26 to 29) discloses a game in which a character (monster) owned by a player is made to grow through battles with enemy characters and by being synthesized with other characters. In the technology of the above Non-patent Document 1, a card-shaped image indicting a character (hereinafter, referred to as a “character image”) and parameters (offensive power, defensive power) of this character are displayed on a display device.

### SUMMARY OF THE INVENTION

In the technology of Non-patent Document 1, characters can be transferred among a plurality of players. For a player receiving a character from another player, it is an important concern whether this character is in an initial state without having been used in games yet (hereinafter, referred to as being in an “initial state”) or in a state in which another player can change parameters of the character or in a state which the parameters were actually changed (these states are referred to as a “used state” below), and there is a tendency for unused characters to be preferred, for example, similar to the exchange of trading cards in real society. However, in the technology of Non-patent Document 1, the character image and the parameters are merely displayed. Thus, there is a problem in that the player cannot intuitively grasp whether the character given to the player is in the initial state or in a used state. In view of the above situation, the present invention has as an object to enable a player to intuitively and immediately grasp whether a character is in an initial state or in a used state.

The present invention is directed to a game apparatus which allows a player to play a game using a character, including a character assignment unit for assigning a character to the player; an information management unit for changing a state of the character assigned to the player from a first state in which a parameter of the character is maintained at an initial value to a second state in which the parameter is changeable; and a display control unit for causing a display device to display a first character image indicating the character if the state of the character is the second state and causing the display device to display a second character image indicating the character in a mode different from the first character image if the state of the character is the first state.

In the above construction, the character is displayed in different modes when the character is in the first state and when the character is in the second state. Thus, there is an advantage that the player can intuitively and immediately grasp in which of the first state and the second state each character is.

The state of the character is changed from the first state to the second state at freely chosen timing. However, for example, in a construction including a receiving unit for receiving an instruction from the player, the information management unit can change the state of the character in accordance with the instruction received by the receiving unit. The above aspect has an advantage that the player can freely select whether to maintain the character owned by the player in the first state or to change the state of the character to the second state and change the parameter.

In which of the first state and the second state the character is in is an important concern for a player who gives characters to and receives characters from other players. Accordingly, the present invention enabling the player to intuitively and immediately grasp in which of the first state and the second state the character is in is particularly effective in the construction in which the character assignment unit assigns a character of one player to another player.

Assuming the exchange of a trading card in a real society, the first state of the character suggests a packaged state (unopened state) of the trading card and the second state of the character suggests an opened state of the trading card. Accordingly, in a preferred aspect of the present invention, the display control unit causes the display device to display the second character image indicating a packaged state of the first character image. According to the above construction, the effect of the present invention to enable the player to intuitively grasp the state of the character is particularly notable.

In a first aspect of the present invention, the display control unit obtains the first character image and causes the display device to display it if the state of the character is the second state and obtains the second character image and causes the display device to display it if the state of the character is the first state. Since the first character image and the second character image are individually prepared for each character in the first aspect, there is an advantage that modes of not only the first character image, but also the second character image can be individually selected for each character. Note that a specific example of the first aspect is described, for example, as a first embodiment later.

In a second aspect of the present invention, the display control unit obtains the first character image of the character and causes the display device to display it if the state of the character is the second state and generates the second character image by synthesizing the first character image of the character and a package image indicating a package and causes the display device to display it if the state of the character is the first state. In the second aspect, the second character image is generated by synthesizing the first character image and the package image. The package image is shared for the generation of a plurality of second character images and need not be prepared for each character. Thus, there is an advantage of reducing storage capacity for storing character images as compared with the construction in which the first character image and the second character image are stored for each character. Note that a specific example of the second aspect is described as a second embodiment later.

In the second aspect, the display control unit preferably synthesizes the first character image reduced in size with the package image. Since the first character image reduced in size is synthesized with the package image in the above aspect, outside dimensions (number of pixels) of the first character image and those of the second character image can approximate each other or can be the same.

In a third aspect of the present invention, the display control unit synthesizes the first character image of the character and a transparent image having the same outside dimensions as a package image indicating a package and causes the display device to display the synthesized image if the state of the character is the second state and generates the second character image by synthesizing the first character image of the character and the package image and causes the display device to display it if the state of the character is the first state. In the third aspect, similar to the second aspect, the second character image is generated by synthesizing the first character image and the package image. Thus, there is an advantage of reducing storage capacity for storing character images as compared with the construction in which the first character image and the second character image are stored for each character. Furthermore, since the transparent image synthesized with the first character image at the time of displaying the first character image and the package image synthesized with the first character image at the time of displaying the second character image have common outside dimensions (number of pixels), there is an advantage of eliminating the need to make the layout of a displayed image different at the time of displaying the first character image and at the time of displaying the second character image. Note that a specific example of the third aspect is described as a third embodiment later.

In a preferred aspect of the present invention, the character assignment unit successively assigns a character to each of a plurality of players and sets different assignment numbers (e.g. serial numbers) for the respective characters commonly assigned to the plurality of players, and the display control unit causes the display device to display the assignment number of the character together with the second character image of the character. Since the assignment number is set for each character and is displayed together with the second character image in the above aspect, the same characters assigned to the plurality of players can be easily distinguished. Note that a specific example of the above aspect is described as a fourth embodiment later.

The present invention is also specified as a program for causing a computer to function as the game game apparatuses according to the above respective aspects. The program of the present invention causes the computer to function as a character assignment unit for assigning a character to a player; an information management unit for changing a state of the character assigned to the player from a first state in which a parameter of the character is maintained at an initial value to a second state in which the parameter is changeable; and a display control unit for causing a display device to display a first character image indicating the character if the state of the character is the second state and causing the display device to display a second character image indicating the character in a mode different from the first character image if the state of the character is the first state. According to the above program, functions and effects similar to those of the game apparatus of the present invention are achieved. The program of the present invention is installed in the computer by being provided from a server device in the form of a delivery via a communication network besides being installed in the computer by being provided to a user while being stored in a non-transitory computer-readable recording medium.

The present invention is also specified as a game providing method for providing a game using a character for a player. The game providing method includes assigning a character to the player; changing a state of the character assigned to the player from a first state in which a parameter of the character is maintained at an initial value to a second state in which the parameter is changeable; and causing a display device to display a first character image indicating the character if the state of the character is the second state and causing the display device to display a second character image indicating the character in a mode different from the first character image if the state of the character is the first state.

### BRIEF DESCRIPTION OF THE DRAWINGS

FIG. 1 is a block diagram of a game system in a first embodiment of the present invention,

FIG. 2 is a diagram of acquired character data;

FIG. 3 is a diagram of a first character image and a second character image;

FIGS. 4A to 4C are diagrams of the operation of the game system;

FIGS. 5A and 5B are diagrams showing a display example of a display device;

FIG. 6 is a diagram showing a display example (list format) of the display device;

FIG. 7 is a diagram of a display image in a second embodiment;

FIG. 8 is a diagram of a display image in a third embodiment;

FIG. 9 is a diagram of acquired character data in a fourth embodiment;

FIGS. 10A and 10B are diagrams showing a display example of a display device in the fourth embodiment; and

FIG. 11 is a block diagram of a game apparatus in a fifth embodiment.

### DETAILED DESCRIPTION OF PREFERRED EMBODIMENTS

### A: First Embodiment

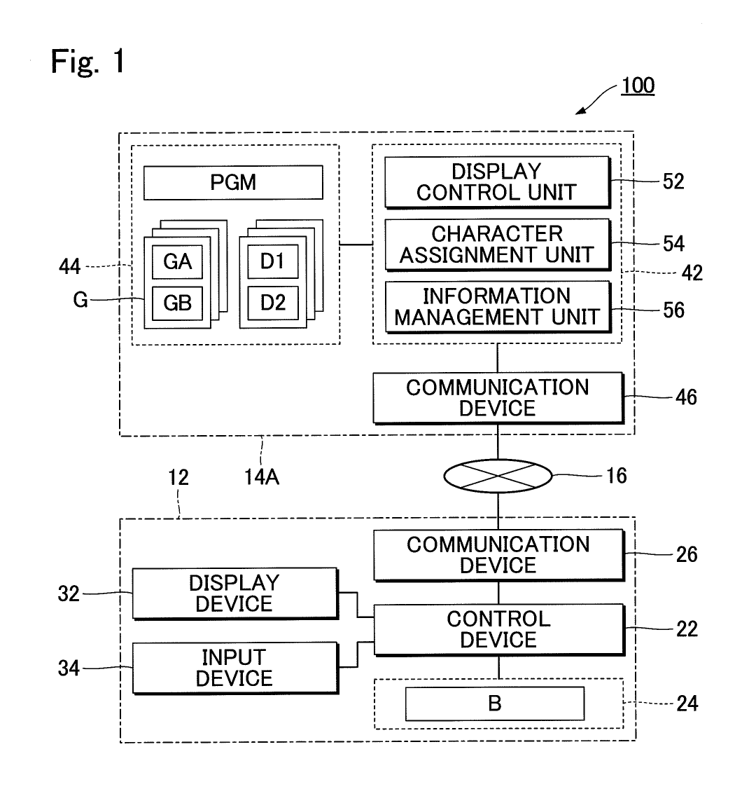

FIG. 1 is a block diagram of a game system 100 according to a first embodiment of the present invention. The game system 100 of the first embodiment is a system for allowing a player to play a game using a character and includes a terminal device 12 and a game apparatus 14A which communicate with each other via a communication network 16. The communication network 16 includes, for example, the Internet, and the terminal device 12 and the game apparatus 14A communicate with each other in a procedure based on a known HTTP (HyperText Transfer Protocol). Note that although only one terminal device 12 is shown for convenience in FIG. 1, a plurality of terminal devices 12 actually communicate with the game apparatus 14A via the communication network 16.

The terminal device 12 is, for example, a communication terminal such as a mobile phone, a personal digital assistant (PDA) or a personal computer and includes a control device 22, a storage device 24, a communication device 26, a display device 32 and an input device 34. The communication device 26 communicates with the game apparatus 14A via the communication network 16. Note that although communication between the communication device 12 and the communication network 16 is typically wireless communication, wired communication between the communication s device 12 and the communication network 16 is also possible, for example, in a configuration using a desktop personal computer as the terminal device 12

The display device 32 (e.g., liquid crystal display panel) displays various images under the control of the control device 22. The input device 34 is a device used by a player to input an instruction to the terminal device 12 and, for example, includes a plurality of manipulators to be operated by a player. Note that it is also possible to adopt a touch panel integrally formed with the display device 32 to receive an operation from a user or a microphone used by the user for voice input of instructions to the terminal device 12 as the input device 34.

The control device 22 centrally controls the respective elements of the terminal device 12 by executing a program. The storage device 24 is, for example, a known recording medium as a semiconductor recording medium, and stores the program to be executed by the control device 22 and various data used by the control device 22. For example, the storage device 24 stores a program B of the web browser.

The game apparatus 14A is a web server for providing a browser game to a player who owns the terminal device 12. The browser game is a game which can be played by executing the program B in the terminal device 12 (game which does not require the downloading of special software for the game to the terminal device 12). That is, the control device 22 of the terminal device 12 requires a web page indicating a game screen to the game apparatus 14A and causes the display device 32 to display the game screen provided in response to the request by executing the program B. A game provided by the game apparatus 14A of the first embodiment is a RPG (Role-Playing Game) type social game in which various events are accomplished in cooperation with other players (friends) using a character such as a monster given to the player.

As shown in FIG. 1, the game apparatus 14A includes a control device 42, a storage device 44 and a communication device 46. The communication device 46 communicates with the terminal device 12 via the communication network 16. For example, the communication device 46 functions as an element (receiving unit) for receiving an instruction from the player to the terminal device 12. The storage device 44 stores a program (game program) PGM to be executed by the control device 42 and various data used by the control device 42. A known recording medium such as a semiconductor recording medium or a magnetic recording medium or a combination of a plurality of types of recording media can be adopted as the storage device 44.

The storage device 44 stores game data G corresponding to a status of the progress of the game for each player. The game data G of each player includes, for example, friend data GA and acquired character data GB. The friend data GA designates identification information of another player registered as a friend of the player.

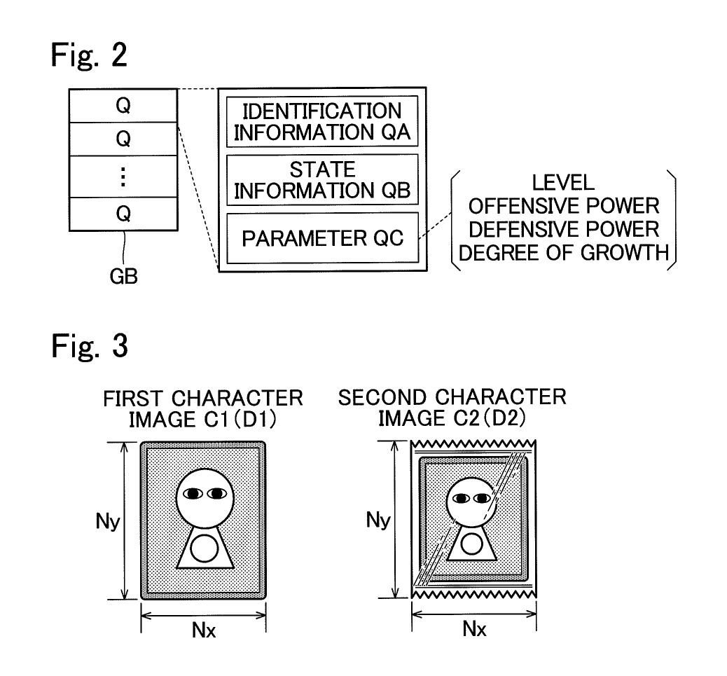

FIG. 2 is a diagram of the acquired character data GB. The acquired character data GB is a set of a plurality of character data Q corresponding to the respective characters the player acquired in the game. Each character data Q includes identification information QA, state information QB and parameters QC. The identification information QA is a code uniquely assigned to the character (e.g., name of the character). The parameter QC is a variable applied to the game. For example, variables concerning the abilities of the character such as level, offensive power, defensive power and a degree of growth (experience point) are designated as the parameters QC. The degree of growth of the character increases as the game progresses by accomplishing various events, and the level, the offensive power and the defensive power increase every time the degree of growth reaches a threshold value.

The state information QB of FIG. 2 is information (flag) indicating in which of a first state (initial state) and a second state (used state) the character is. The first state means a state in which the parameters QC of the character are maintained at predetermined initial values, and the second state means a state in which the parameters QC of the character can be changed and a state in which the parameters QC have been actually changed. Specifically, the state information QB is set at a numerical value “0” when the character is in the first state while being set at a numerical value “1” when the character is in the second state.

Furthermore, the storage device 44 of FIG. 1 stores image data D (D1, D2) of images of each character (character images) that can appear in the game. For one character, the image data D1 of a first character image C1 and the image data D2 of a second character image C2 are generated in advance and stored in the storage device 44. The first and second character images C1, C2 represent the same character in different modes (pictures).

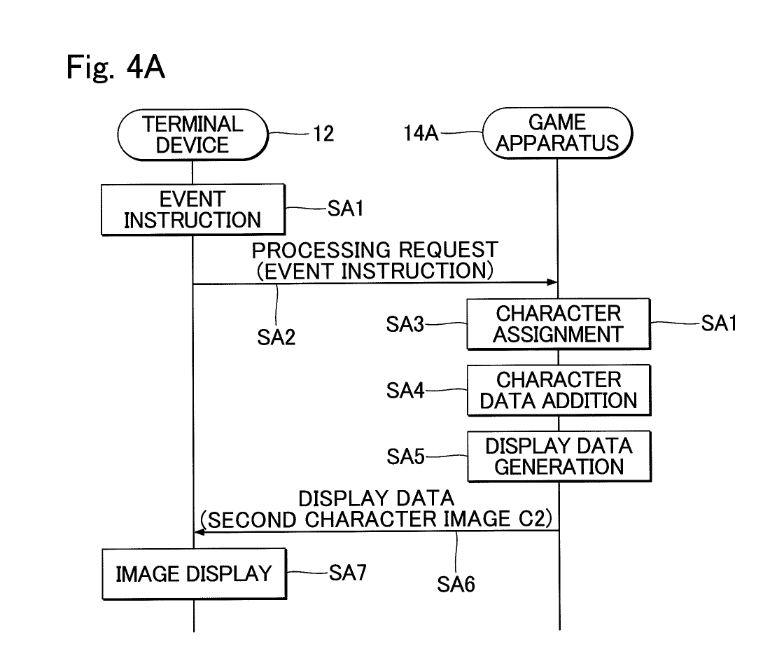

FIG. 3 is a diagram of the first character image C1 and the second character image C2. The first character image C1 is a substantially rectangular image simulating a trading card on which a picture of the character is drawn. On the other hand, the second character image C2 is an image simulating a packaged, unopened state of the trading card. For example, as shown in FIG. 3, an image in a state in which the trading card indicated by the first character image C1 is packaged in a transparent package (i.e., a state in which the first character image C1 inside can be seen through the package) is prepared as the second character image C2. Outside o dimensions (number of pixels Nx in a horizontal direction and number of pixels Ny in a vertical direction) of an image are common to the first character image C1 and the second character image C2. The image data D1 indicating the first character image C1 and the image data D2 indicating the second character image C2 are stored in the storage device 44 for each of a plurality of characters.

Note that although a unit (information storage unit) for storing the game data G and a unit (image storage unit) for storing the image data D are realized by the single storage device 44 in the example of FIG. 1, it is also possible to realize the respective units (information storage unit, image storage unit) by a plurality of separate storage devices.

The control device 42 of FIG. 1 realizes a plurality of functions (display control unit 52, character assignment unit 54, information management unit 56) to provide the game to the player owning the terminal device 12 by executing the program PGM stored in the storage device 44. Note that it is also possible to distribute the respective functions of the control device 42 among a plurality of arithmetic processing units.

The display control unit 52 causes the display device 32 of the terminal device 12 executing the program B of the web browser to display various game screens as a response (HTTP response) to a processing request (HTTP request) from the terminal device 12. Specifically, the display control unit 52 generates display data indicating a game screen corresponding to a status of the progress of the game as needed in response to the processing request from the terminal device 12 and transmits it from the communication device 46 to the terminal device 12. The display data is data of the HTML (HyperText Markup Language) format including, for example, information on letters, hyperlinks, and character images constituting the game screen (e.g., file name). The control device 22 of the terminal device 12 causes the display device 32 to display the game screen in accordance with the display data received from the game apparatus 14A via the communication device 26.

The character assignment unit 54 of FIG. 1 assigns a character to the player when a predetermined event (hereinafter, referred to as a “character assignment event”) in the game occurs. The character assignment event is, for example, an event of acquiring a character from a treasure box discovered when a cave was searched or an event of acquiring a character by a predetermined drawing process. When the character assignment event occurs, the character assignment unit 54 determines any one of a plurality of characters by a drawing process and assigns it to the player. The information management unit 56 updates the game data G stored in the storage device 44 as needed with the progress of the game.

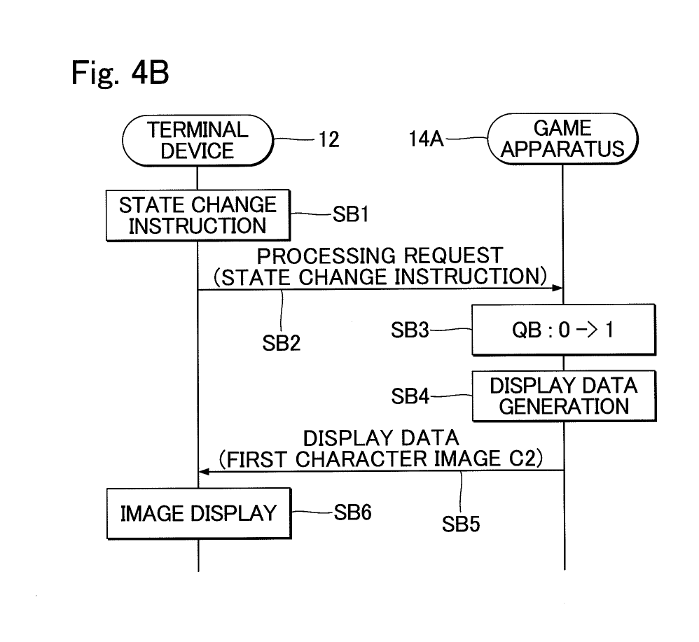

FIGS. 4A to 4C are diagrams of the overall operation of the game system 100. As shown in FIG. 4A, the player can instruct the occurrence of a character assignment event by appropriately operating the input device 34 (e.g. selects a desired hyperlink in the game screen) while confirming the game screen displayed on the display device 32 of the terminal device 12 (SA1). The control device 22 of the terminal device 12 transmits a processing request indicating the character assignment event instructed from the player from the communication device 26 to the game apparatus 14A (SA2).

When the communication device 46 receives the processing request of the step SA2, the character assignment unit 54 of the game apparatus 14A selects one character (hereinafter, referred to as a “new character”), for example, by a predetermined drawing process and assigns it to the player (SA3). The information management unit 56 adds character data Q of the new character to the acquired character data GB of the player (SA4). In the character data Q added in the step SA4, state information QB is set at a numerical value “0” indicating the first state and the respective numerical values of the parameters QC are set at initial values unique to this character.

The display control unit 52 generates display data of a game screen notifying the new character assigned in the step SA3 to the player (SA5). The display data generated in the step SA5 includes identification information QA, parameters QC and image data D of the new character. The state information QB of the new character is set at the numerical value “0” indicating the first state as described above. If the state information QB indicates the first state, the display control unit 52 designates the image data D2 of the second character image C2 as the image data D of the display data to be provided to the terminal device 12. The display control unit 52 transmits the display data generated in the step SA5 as a response to the processing request of the step SA2 from the communication device 46 to the terminal device 12 (SA6).

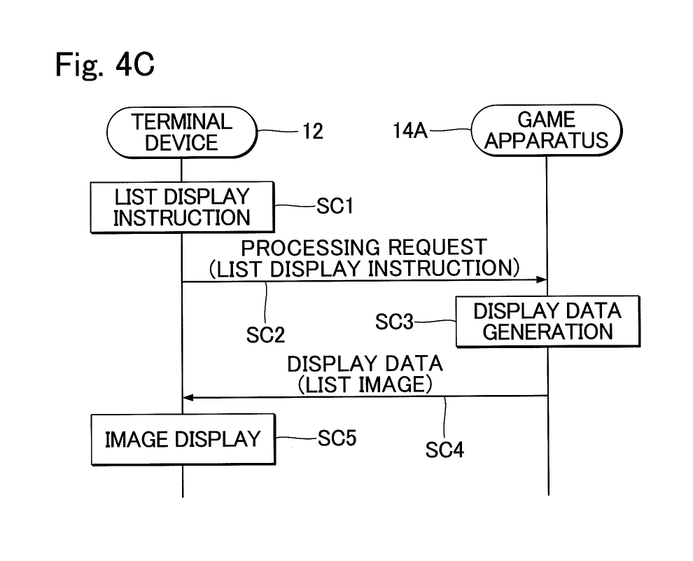

When the communication device 26 receives the display data transmitted in the step SA6, the control device 22 of the terminal device 12 causes the display device 32 to display the game screen indicated by this display data (SA7). Specifically, as shown in FIG. 5A, the second character image C2 of the new character is displayed on the display device 32 together with the identification information (character name) QA and the respective numerical values of the parameters QC. That is, the second character image C2 indicating the packaged state (i.e., unopened new state) is displayed for the new character in the first state that was assigned to the player by the character assignment event. Accordingly, the player can intuitively grasp that the new character assigned to the player is in the first state. Note that, at the time of the occurrence of the character assignment event of assigning the new character by the predetermined drawing process, it is also possible to display moving images (animation) representing a state of drawing the new character to be assigned to the player as the game screen in the step SA7.

As shown in FIG. 4B, the player can instruct a change of the state information QB (change from the first state to the second state) for an freely selected character (hereinafter, referred to as a “target character”) owned by the player by appropriately operating the input device 34 while confirming the game screen displayed on the display device 32 (SB1). If a change of the state information QB is instructed, the control device 22 of the terminal device 12 transmits a processing request indicating the target character from the communication device 26 to the game apparatus 14A (SB2).

When the communication device 46 receives the processing request transmitted in the step SB2, the information management unit 56 of the game apparatus 14A changes the state information QB of the character data Q of the target character indicated by the processing request out of the acquired character data GB of the player from the present numerical value “0” indicating the first state to the numerical value “1” indicating the second state (SB3). Note that it is prohibited to change the state indicated by the state information QB from the second state to the first state.

The display control unit 52 generates display data of a game screen notifying the change of the state information QB to the player (SB4). The display data generated in the step SB4 includes identification information QA, parameters QC and image data D of the target character. The state information QB of the target character was changed from the numerical value “0” to the numerical value “1” in the step SB3. If the state information QB indicates the second state, the display control unit 52 designates the image data D1 of the first character image Cl as the image data D of the display data generated in the step SB4. The display control unit 52 transmits the display data generated in the step SB4 as a response to the processing request of the step SB2 to the terminal device 12 (SB5).

When the communication device 26 receives the display data transmitted in the step SB5, the control device 22 of the terminal device 12 causes the display device 32 to display the game screen indicated by this display data (SB6). Specifically, as shown in FIG. 5B, the first character image C1 of the target character is displayed on the display device 32 together with the identification information QA and the respective numerical values of the parameters QC. That is, the second character image C2 indicating the packaged state is changed to the first character image C1 in the second state by opening the package when the instruction of the step SB1 is given. Accordingly, the player can intuitively grasp that the state of the character displayed on the display device 32 has been changed to the second state. Note that, at the time of changing the second character image C2 to the first character image C1, it is also possible to display moving images (animation), in which the second character image C2 is changed to the first character image C1 with time, on the display device 32.

As shown in FIG. 4C, the player can instruct a list display of the characters owned by the player by appropriately operating the input device 34 (SC1). The control device 22 of the terminal device 12 transmits a processing request instructing a list display of already acquired characters from the communication device 26 to the game apparatus 14A (SC2). When the communication device 46 receives the processing request of the step SC2, the display control unit 52 of the game apparatus 14A generates display data in which the identification information QA, the parameters QC and the image data D are designated to each of a plurality of characters registered in the acquired character data GB (SC3). In the display data generated in the step SC3, the image data D2 of the second character image C2 is designated for the characters whose state information QB is set at the initial value “0” indicating the first state out of the plurality of characters owned by the player and the image data D1 of the first character image C1 is designated for the characters whose state information QB is set at the numerical value “1” indicating the second state. The display control unit 52 transmits the display data generated in the step SC3 as a response to the processing request of the step SC2 to the terminal device 12 (SC4).

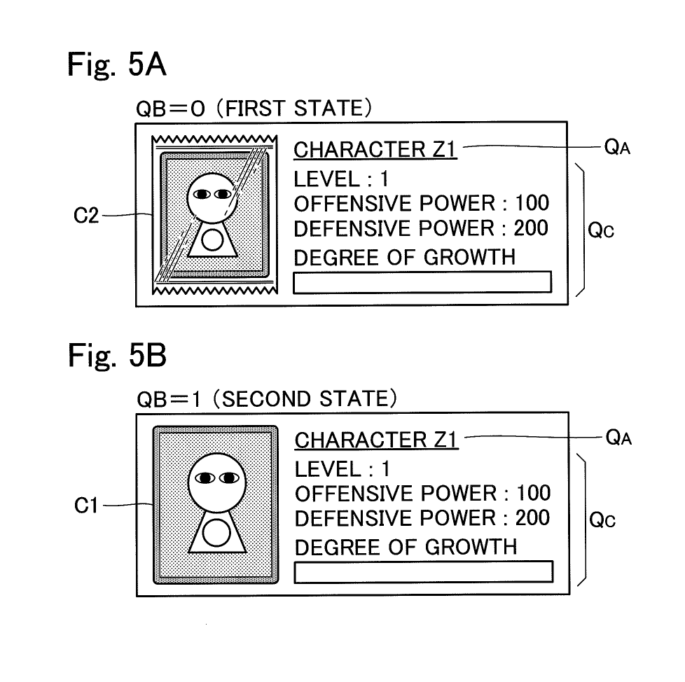

When the communication device 26 receives the display data transmitted in the step SC4, the control device 22 of the terminal device 12 causes the display device 32 to display the identification information QA, the character image C (C1, C2) and the parameters QC for each of the plurality of characters owned by the player as shown in FIG. 6 (SC5). The second character image C2 indicating the packaged state is displayed for the characters in the first state (e.g., characters Z1 and Z2 of FIG. 6), and the first character image C1 indicating the opened state is displayed for the characters (e.g., character Z3 of FIG. 6) whose state was changed to the second state out of the plurality of characters displayed on the display device 32. Accordingly, the player can intuitively and immediately grasp in which of the first state and the second state each of the plurality of characters owned by the player is.

When the player selects a desired character in the first state out of the plurality of characters displayed in a list format as shown in FIG. 6 and instructs a change of the state information QB, the state information QB of this character is changed from the numerical value “0” to the numerical value “1” by performing steps similar to the steps SB2 to SB5, and the image displayed on the display device 32 of the terminal device 12 is changed from the second character image C2 to the first character image C1.

The player can freely select a character in the second state out of the plurality of characters owned by the player and instruct the occurrence of an event of changing the parameters QC of this character (hereinafter, referred to as a “character growth event”). The character growth event is, for example, an event of synthesizing a plurality of characters owned by the player or an event of causing the player's own character to fight with a character of another player. The characters in the first state out of the plurality of characters displayed in the list format on the display device 32 are excluded from selection for the character growth event. When receiving a processing request of the character growth event from the terminal device 12, the information management unit 56 of the game apparatus 14A changes the parameters QC of the character designated by the player by a predetermined operation.

Furthermore, the player can transfer characters to and from other players registered in the friend data GA. The character assignment unit 54 assigns a character of another player “b” to a player “a” when a predetermined event (e.g., an event in which the player “a” obtains a character from the other player “b” or an event in which the player “a” seizes a character of the other player “b”) occurs. If the character of the player “b” is assigned to the player “a”, the information management unit 56 deletes character data Q of this character from acquired character data GB of the player “b” and adds it to acquired character data GB of the player “a” and the display control unit 52 causes the display device 32 of the terminal device 12 to display a list of the respective characters designated by the acquired character data GB of the player “a” after the addition as in the example of FIG. 6. For the character assigned from the player “b”, the second character image C2 is displayed if the first state at the time of being assigned to a player “b” is maintained and the first character image Cl is displayed if the player “b” already changed the parameters QC at a character growth event. Thus, the player can intuitively and immediately grasp in which of the first state and the second state the character obtained from the other player is.

In the first embodiment, the display mode of the character image differs depending on whether the state is in the first state in which the initial values of the parameters QC of the character are maintained at initial values or in the second state in which the parameters QC of the character can be changed (or actually already changed). Accordingly, there is an advantage that the player can intuitively and immediately grasp in which of the first state and the second state each character is. Particularly in the first embodiment, since the first character image C1 indicating the already opened trading card is displayed for the characters in the second state and the second character image C2 indicating the packaged trading card is displayed for the characters in the first state, an effect that the player can intuitively and immediately grasp in which of the first state and the second state each character is in is particularly notable.

Note that, as a method by which the display control unit 52 of the game apparatus 14A determines in which of the first state and the second state each character is in, a method of determining that the character is in the second state when actual numerical values of the parameters QC of the character and the initial values of the parameters QC of this character are compared and found to be different (hereinafter, referred to as a “comparative example 1”) can be, for example, supposed in addition to the above method using the state information QB. However, since the actual numerical values and the initial values of the parameters QC need to be compared for each character in the comparative example 1, there is a problem of a large processing load of the display control unit 52. On the other hand, since the state information QB is set for each character in the first embodiment, the actual numerical values and the initial values of the parameters QC need not be compared. Therefore, there is an advantage of reducing the processing load of the display control unit 52 as compared with the comparative example 1.

### B: Second Embodiment

A second embodiment of the present invention is described below. In the first embodiment, the image data D1 of the first character image C1 and the image data D2 of the second character image C2 are stored for each character in the storage device 44. In the second embodiment, image data D2 is generated by processing image data D1. Note that elements having actions and functions equivalent to the first embodiment are denoted by the reference numerals used in the above description and detailed description of the respective elements are appropriately omitted in respective embodiments illustrated below.

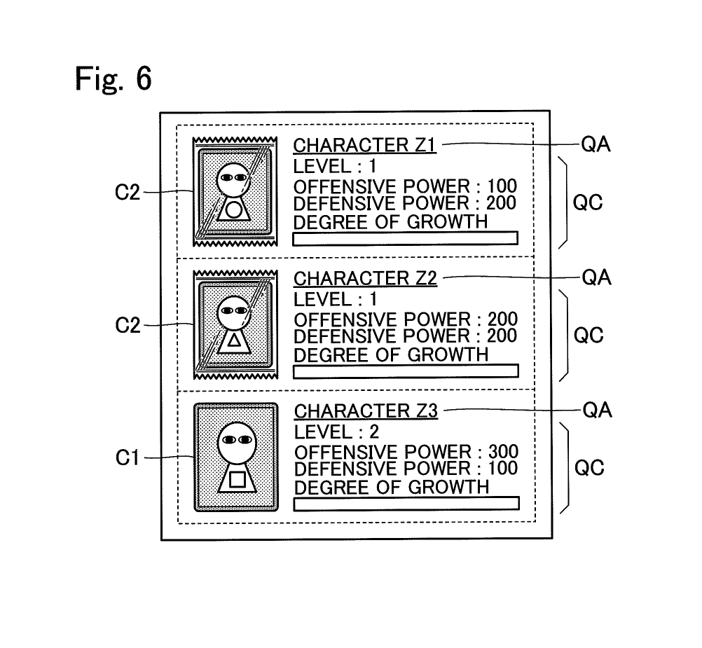

As shown in FIG. 7, a storage device 44 of the second embodiment stores image data D1 of a first character image C1 in an opened state for each character and image data DP of a package image CP representing a package. The package image CP is an image simulating a transparent package packing a trading card. Outside dimensions (number of pixels Nx in a horizontal direction and number of pixels Ny in a vertical direction) of an image are common to the first character image C1 and the package image CP. As shown in FIG. 7, the package image CP includes a first area A1 that is supposed to overlap the trading card packaged by the package and a frame-shaped second area A2 surrounding the first area A1. Most of the first area A1 is transparent and the outer shape of the package is drawn in the second area A2.

If state information QB of a character is a numerical value “1” indicating a second state, a display control unit 52 causes a display device 32 of a terminal device 12 to display the first character image C1 indicated by the image data D1 similarly to the first embodiment. On the other hand, if the state information QB of the character is a numerical value “0” indicating a first state, the display control unit 52 generates the image data D2 of the second character image C2 by synthesizing the first character image C1 indicated by the image data D1 and the package image CP indicated by the image data DP and causes the display device 32 of the terminal device 12 to display it. That is, the package image CP is commonly applied for the generation of second character images C2 of a plurality of characters.

Specifically, as shown in FIG. 7, the display control unit 52 reduces the first character image C1 in size so as to have outside dimensions to be included in the first area A1 of the package image CP, and generates the second character image C2 (image data D2) by synthesizing the package image CP on the front face of the first character image C1 in a superimposition manner. Accordingly, similarly to the first embodiment, the outside dimensions (number of pixels Nx in the horizontal direction and number of pixels Ny in the vertical direction) of an image are common to the first character image C1 and the second character image C2.

In the second embodiment as well, effects similar to those of the first embodiment are achieved. Furthermore, since the second character image C2 in the packaged state is generated by synthesizing the first character image C1 prepared for each character and the package image CP common to each character in the second embodiment, there is an advantage of reducing capacity required for the storage device 44 as compared with the first embodiment in which the second character image C2 is prepared for each character. Note that, according to the first embodiment in which the first character image C1 and the second character image C2 are prepared for each character, a packaged mode indicated by the second character image C2 can be made different for each character.

In image synthesis with the package image CP without changing the size of the first character image C1 (hereinafter, referred to as a “comparative example 2”), the outside dimensions of the second character image C2 obtained by synthesizing the first character image C1 and the package image CP exceed those of the first character image C1 since the package image CP is set to have the outside dimensions larger than those of the first character image C1. Accordingly, in the comparative example 2, the layout (size of an area where each character image is displayed) of the displayed image needs to be made different at the time of displaying the first character image C1 and at the time of displaying the second character image C2. On the other hand, since the first character image C1 is reduced in size in the case of being synthesized with the package image CP in the second embodiment, the outside dimensions of an image can be made the same as the first character image C1 and the second character image C2. Therefore, there is an advantage of eliminating the need to make the layout of a displayed image different at the time of displaying the first character image C1 and at the time of displaying the second character image C2.

### C: Third Embodiment

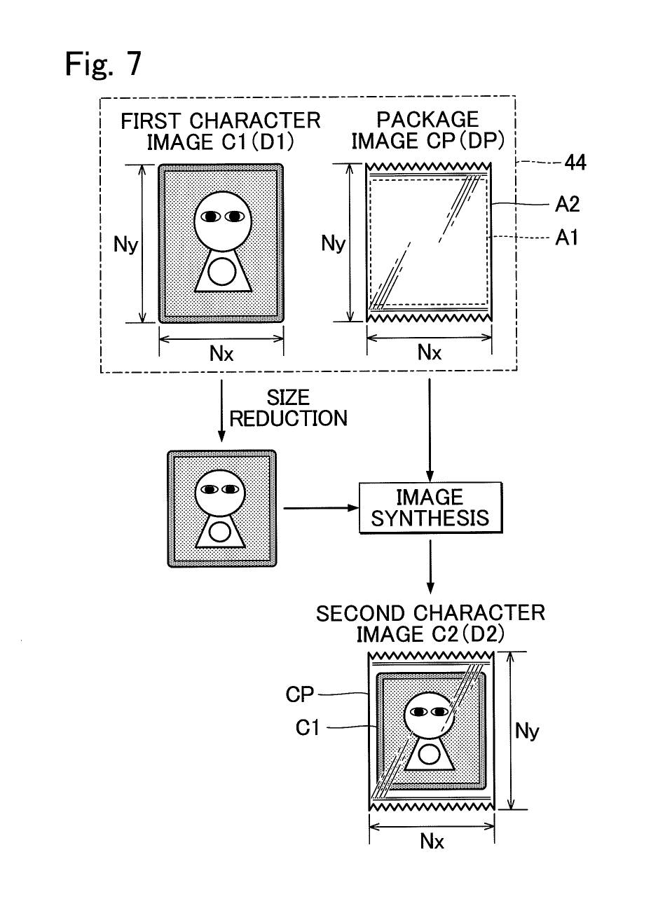

As shown in FIG. 8, a storage device 44 of a third embodiment stores image data D1 of a first character image C1 in an opened state for each character and stores image data DP of a package image CP representing a package by a first area A1 and a second area A2 similar to the second embodiment and image data DT of a transparent image CT. The transparent image CT is a transparent image (e.g. transparent GIF) through which a background image can be seen. Outside dimensions (number of pixels Nx in a horizontal direction and number of pixels Ny in a vertical direction) of an image are the same as the package image CP and the transparent image CT. On the other hand, the first character image C1 is set to have outside dimensions to be included in the first area A1 of the package image CP (i.e., dimensions smaller than those of the package image CP and the transparent image CT).

If state information QB of a character is a numerical value “0” indicating a first state, a display control unit 52 generates image data D2 of a second character image C2 by synthesizing the first character image C1 indicated by the image data D1 and the package image CP indicated by the image data DP and causes a display device 32 of a terminal device 12 to display it similarly to the second embodiment. On the other hand, if the state information QB of the character is a numerical value “1” indicating a second state, the display control unit 52 synthesizes the first character image C1 indicated by the image data D1 and the transparent image CT indicated by the image data DT and causes the display device 32 of the terminal device 12 to display the synthesized image. Specifically, as shown in FIG. 8, the first character image C1 is arranged at such a position as to be included within the peripheral edge of the transparent image CT in a plan view. Thus, the outside dimensions of an image are common at the time of displaying the first character image C1 and at the time of displaying the second character image C2.

In the third embodiment as well, effects similar to those of the first embodiment are achieved. Since the second character image C2 in the packaged state is generated by synthesizing the first character image C1 prepared for each character and the package image CP common to each character in the third embodiment, capacity required for the storage device 44 can be reduced similarly to the second embodiment as compared with the first embodiment in which the second character image C2 is prepared for each character. Furthermore, since the first character image C1 is displayed by being synthesized with the transparent image CT having the outside dimensions equivalent to those of the package image CP, there is also an advantage of eliminating the need to make the layout of a displayed image different at the time of displaying the first character image C1 and at the time of displaying the second character image C2 similarly to the second embodiment. Furthermore, since the first character image C1 need not be reduced in size, a processing load of the display control unit 52 can be reduced as compared with the second embodiment.

### D: Fourth Embodiment

A character assignment unit 54 of a fourth embodiment assigns a specific character (hereinafter, referred to as a “specific character”) out of a plurality of characters to each player only a predetermined limited number of times M. The character assignment unit 54 sets an assignment number QD every time the specific character is assigned to a player. The assignment number QD is a serial number that is incremented by 1 every time one specific character is assigned to any of the respective players. Accordingly, a different assignment number QD is set for each of the specific characters assigned to a plurality of players. When the assignment number QD reaches the limited number of times M, the assignment of this specific character is finished.

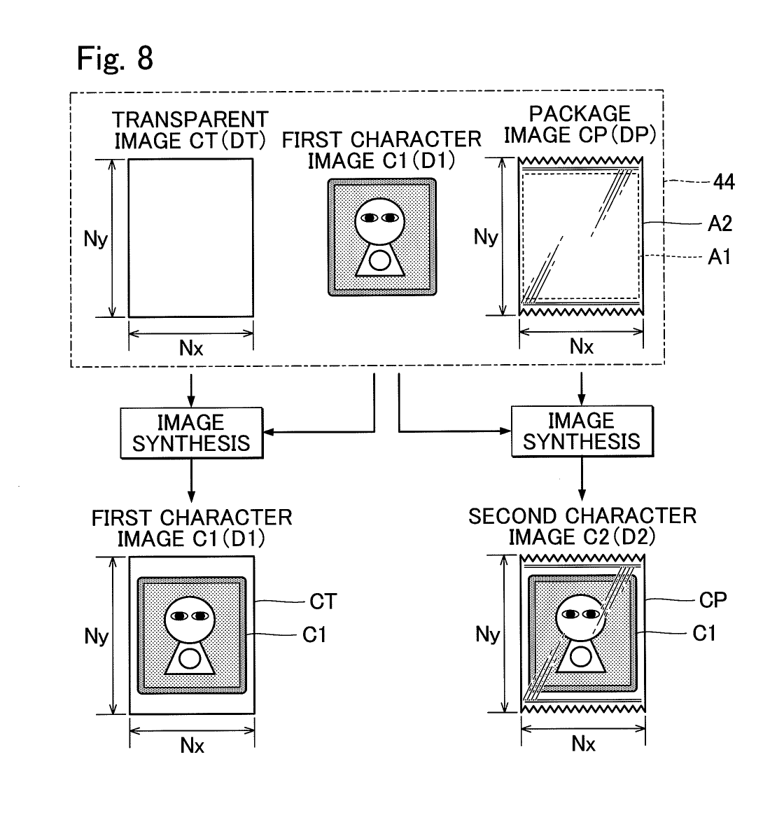

FIG. 9 is a diagram of acquired character data GB stored in a storage device 44 of the fourth embodiment. As shown in FIG. 9, character data Q of the specific character out of the acquired character data GB of the fourth embodiment includes the assignment number QD set by the character assignment unit 54 for this specific character in addition to elements (identification information QA, state information QB, and parameters QC) similar to those of the first embodiment.

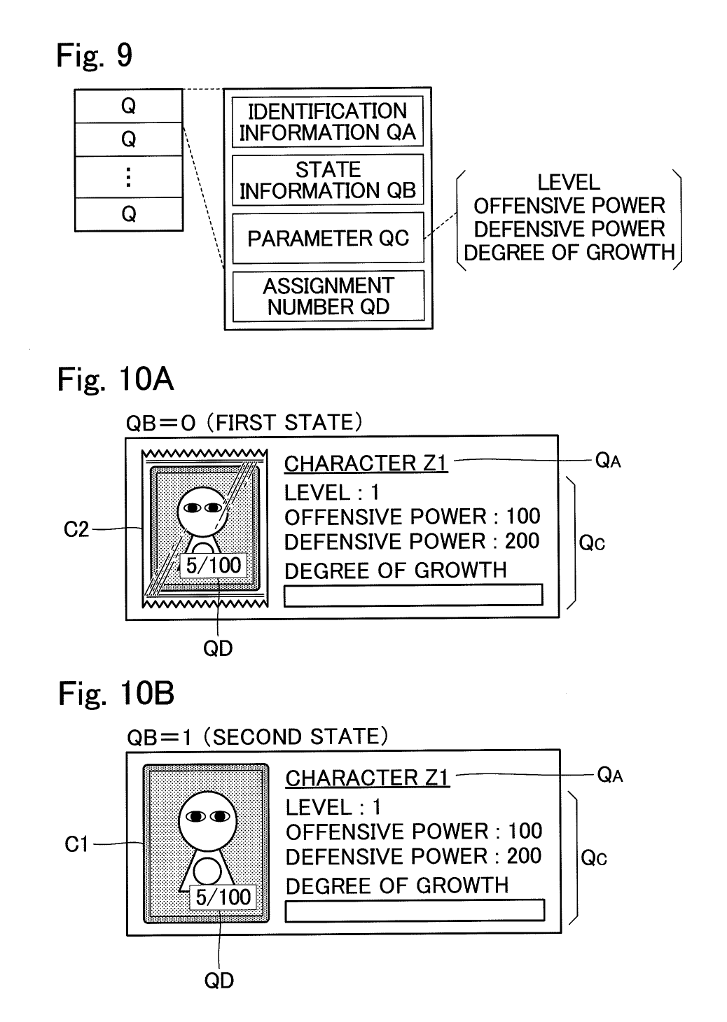

The display control unit 52 of a game apparatus 14A causes a display device 32 of a terminal device 12 to display an assignment number QD of a specific character together with character images C (C1, C2) of this specific character. For example, if a new character assigned at a character assignment event is a specific character, the display control unit 52 generates and transmits display data including an assignment number QD of the new character in addition to identification information QA, image data D2 and parameters QC of the new character (SA5, SA6). In the terminal device 12 having received the display data, the identification information QA, the parameters QC and the second character image C2 are displayed on the display device 32 similarly to the first embodiment as shown in FIG. 10A, and the assignment number QD is displayed while being superimposed on the second character image C2 (SA7). A case in which the assignment number QD (QD=5) and the limited number of times M (M=100) are displayed together is shown in FIG. 10A. The same holds also for a case in which the first character image C1 of the specific character is displayed on the display device 32 of the terminal device 12 (SB4 to SB6), and the display control unit 52 causes the display device 32 of the terminal device 12 to display the assignment number QD of the specific character together with the first character image C1 of this character as shown in FIG. 10B. Note that it is also possible to display the assignment number QD only at the time of displaying the second character image C2 (the assignment number QD is not displayed at the time of displaying the first character image C1).

In the fourth embodiment as well, effects similar to those of the first embodiment are achieved. Furthermore, since the assignment number QD is displayed together with the character images C (C1, C2) of the specific character in the fourth embodiment, a sense of rareness (sense of premium) can be given to the player who acquired the specific character. Furthermore, there is also an advantage that, if plural specific characters are assigned to one player, the respective specific characters can be distinguished by the assignment numbers QD. Although the specific characters out of a plurality of kinds of characters are assigned to the players only by the limited number of times M in the above example, it is also possible to assign the assignment number QD for all kinds of the characters or not to limit the number of assignment of the characters. Note that the constructions of the second and third embodiments can be also similarly applied to the fourth embodiment.

### E: Fifth Embodiment

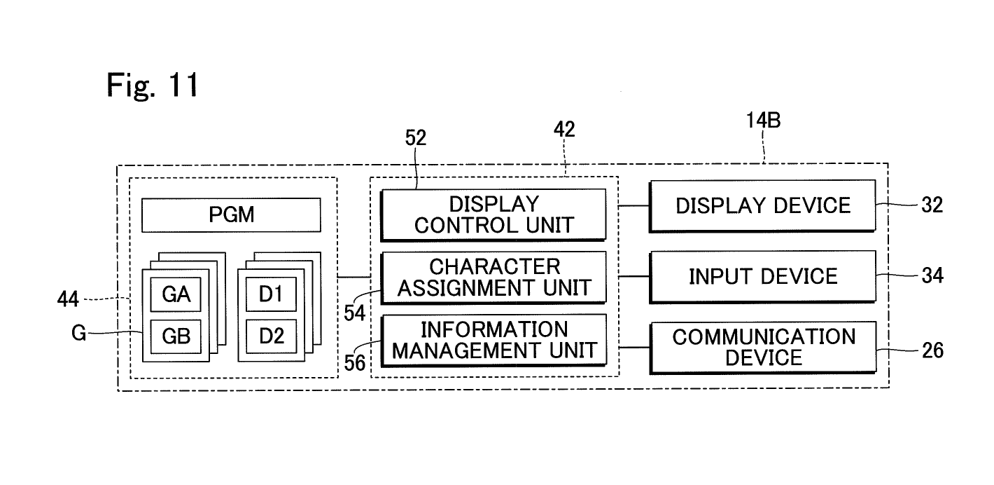

FIG. 11 is a block diagram of a game apparatus 14B of a fifth embodiment. The game apparatus 14B is a mobile electronic device which allows a player (owner) to play a game similar to the first embodiment and includes a control device 42, a storage device 44, a communication device 26, a display device 32 and an input device 34. The input device 34 functions as an element for receiving an instruction from the player (receiving unit).

The storage device 44 stores a program PGM which provides a game to a player, game data G (friend data GA, acquired character data GB) of the player and image data D (D1, D2) of each character. The program PGM, the game data G and the image data D are delivered from a server device, for example, via a communication network (not shown) and stored in the storage device 44. The communication device 26 transfers characters by communication with other game apparatus 14B (e.g., short-distance communication such as infrared communication).

The control device 42 functions as elements (display control unit 52, character assignment unit 54, information management unit 56) similar to the first embodiment by executing the program PGM. The operations of the respective elements of the control device 42 are similar to those of the first embodiment. For example, the display control unit 52 causes the display device 32 to display a second character image C2 of a character if the state information QB of this character to be displayed indicates a first state, and causes the display device 32 to display a first character image C1 of the character if the state information QB of the character indicates a second state.

That is, the game apparatus 14B of the fifth embodiment functions as a device which singly provides the game provided by the game apparatus 14A in the first embodiment. Accordingly, in the fifth embodiment as well, effects similar to those of the first embodiment are achieved. As can be understood from the above description, the display control unit 52 and the display device 32 may be installed in separate devices (game apparatus 14A and terminal device 12) as illustrated in the first embodiment or may be installed in a single device (game apparatus 14B) as illustrated in the fifth embodiment. Note that the constructions of the second to fourth embodiments are also similarly applied to the fifth embodiment.

### F: Modifications

The respective embodiments described above can be modified in various manners. Specific modes of modification are illustrated below. Two or more modes freely selected from the following examples can be appropriately combined without contradicting each other.

(1) In the above respective embodiments, an instruction to change the state of the character from the first state to the second state is given independently of other instructions such as the one for the occurrence of an event. However, an instruction for the occurrence of a character growth event may, for example, double as an instruction to change the state of the character from the first state to the second state. That is, if a player freely selects a character in the first state and instructs the occurrence of a character growth event, the information management unit 56 changes a state indicated by the state information QB of this character from the first state (QB=0) to the second state (QB=1). Since an independent instruction to change the state of the character from the first state to the second state is unnecessary in the above construction, a burden on the player can be reduced.

(2) Although the state information QB is changed when an instruction is given from the player in the above respective embodiments, the state indicated by the state information QB can be changed from the first state to the second state at a freely selected timing. For example, it is also possible to change the state information QB of a character (change an image to be displayed on the display device 32 from the second character image C2 to the character image C1) after the elapse of a predetermined time after this character is assigned to the player.

(3) Although it is prohibited to change the state indicated by the state information QB from the second state to the first state in the above respective embodiments, it is also possible to permit a change from the second state to the first state. However, if a change from the second state to the first state is permitted without any limitation, the meaning of transferring characters maintained in the first state to and from other players is diminished. Thus, it is preferable to permit a change from the second state to the first state, for example, only when a predetermined condition such as the completion of a billing process holds.

(4) Although the second state is a state in which the parameters QC of the character are changeable in the above respective embodiments, it is also possible to set a state in which the parameters QC of the character are actually changed from the initial values as the second state. That is, the second state means both the state in which the parameters QC of the character are changeable (it does not matter whether or not they were changed) and the state in which the parameters QC of the character are actually changed.

What is claimed is:

1. A game apparatus for allowing a player to play a game using a character, the game apparatus comprising:
a character assignment unit for assigning a character to the player;
an information management unit for changing a state of the character assigned to the player from a first state in which a parameter of the character is maintained at an initial value to a second state in which the parameter is changeable; and
a display control unit for causing a display device to display a first character image indicating the character if the state of the character is the second state and causing the display device to display a second character image indicating the character in a mode different from the first character image if the state of the character is the first state.

2. The game apparatus according to claim 1, further comprising a receiving unit for receiving an instruction from the player,
wherein the information management unit can change the state of the character in accordance with the instruction received by the receiving unit.

3. The game apparatus according to claim 1, wherein the character assignment unit assigns a character of one player to another player.

4. The game apparatus according to claim 1, wherein the display control unit causes the display device to display the second character image indicating a packaged state of the first character image.

5. The game apparatus according to claim 1, wherein the display control unit obtains the first character image of the character and causes the display device to display it if the state of the character is the second state and obtains the second character image and causes the display device to display it if the state of the character is the first state.

6. The game apparatus according to claim 1, wherein the display control unit obtains the first character image of the character and causes the display device to display it if the state of the character is the second state and generates the second character image by synthesizing the first character image of the character and a package image indicating a package and causes the display device to display it if the state of the character is the first state.

7. The game apparatus according to claim 6, wherein the display control unit synthesizes the first character image reduced in size with the package image.

8. The game apparatus according to claim 1, wherein the display control unit synthesizes the first character image of the character and a transparent image having the same outside dimensions as a package image indicating a package and causes the display device to display the synthesized image if the state of the character is the second state and generates the second character image by synthesizing the first character image of the character and the package image and causes the display device to display it if the state of the character is the first state.

9. The game apparatus according to claim 1,
wherein the character assignment unit successively assigns a character to each of a plurality of players and sets different assignment numbers for the respective characters commonly assigned to the plurality of players, and
wherein the display control unit causes the display device to display the assignment number of the character together with the second character image of the character.

10. A game providing method for providing a game using a character for a player, the game providing method comprising:
assigning a character to the player;
changing a state of the character assigned to the player from a first state in which a parameter of the character is maintained at an initial value to a second state in which the parameter is changeable; and
causing a display device to display a first character image indicating the character if the state of the character is the second state and causing the display device to display a second character image indicating the character in a mode different from the first character image if the state of the character is the first state.
